(19) United States
(12) Patent Application Publication
(10) Pub. No.: US 2026/0048530 A1
(43) Pub. Date: Feb. 19, 2026

(54) Method and System of Separating Plastics Using a Covered Screen Bed

(71) Applicant: Thomas A Valerio, Atlanta, GA (US)

(72) Inventor: Thomas A Valerio, Atlanta, GA (US)

(21) Appl. No.: 19/369,415

(22) Filed: Oct. 27, 2025

Related U.S. Application Data
(63) Continuation of application No. PCT/US2024/026353, filed on Apr. 25, 2024.
(60) Provisional application No. 63/461,895, filed on Apr. 25, 2023.
(60) Provisional application No. 63/522,842, filed on Jun. 23, 2023.

(51) Int. Cl. B29B 17/02; B03B 5/34; B03B 9/06; B03B 11/00

(52) U.S. Cl. CPC B29B 17/02; B03B 5/34; B03B 9/061; B03B 11/00; B29B 2017/0203; B29B 2017/0224; B29B 2017/0231; B29B 2017/0234; B29B 2017/0244

(57) ABSTRACT

A method and system for separating materials using a combination of screen beds and gravity separators is included. Materials are collected from the waste stream and pass through a screen. The collected larger materials are then directed to a first gravity separator with a specific gravity. Plastics are recovered and residual metals are recovered.

### PRIOR RELATED APPLICATION DATA

This is application a continuation of International Patent Application No. PCT/US2024/026353, filed on Apr. 25, 2024, which claims the benefit of U.S. Provisional Patent Application No.63/461,895, filed Apr. 25, 2023, and U.S. Provisional Patent Application No.63/522,842, filed Jun. 23, 2023, each of which is incorporated by reference herein in its entirety.

### TECHNICAL FIELD

This disclosure relates to systems and methods for separating plastics in a waste stream. More particularly, this disclosure relates to systems and methods that employ a method or system with a covered screen bed to separate materials in a recycling or waste recovery operation.

### BACKGROUND

Recycling waste materials is crucial for several reasons, particularly from environmental and economic perspectives. Properly sorted recyclable materials can yield significant financial returns by being sold for revenue. Additionally, many valuable recyclable materials are not biodegradable within a short timeframe, so recycling them helps reduce pressure on local landfills and mitigates environmental impact. This results in less pollution, decreased resource depletion, and a smaller carbon footprint.

Waste streams typically consist of various types of materials that can be recycled to produce aggregates and recover valuable metals. These aggregates can be of substantial value, especially when they are relatively clean. An example of a waste stream is from the recycling of automobiles, large machinery, or appliances. At the end of its lifespan, an automobile is shredded, and the resulting material is processed to recover ferrous and non-ferrous metals. The remaining waste, known as automobile shredder residue (ASR), still contains valuable ferrous and nonferrous metals, such as copper, along with other recyclable materials like plastics. Generally, ASR is disposed of in landfills, but there are ongoing efforts to further recover non-ferrous metals and plastics from these waste streams. Similar processes are applied to whitegood shredder residue (WSR), which involves the waste generated after recovering ferrous metals from shredded machinery or large appliances. Other types of waste streams with recoverable materials include electronic components (“e-waste” or waste electrical and electronic equipment (WEEE)), building components, retrieved landfill material, and other industrial waste streams. For example, U.S. Pat. No. 6,024,226 A describes a system and process for separating and recovering materials from solid waste streams, while WO 2012/146974 A1 details a device and method for separating shredder fractions.

Within a given waste stream, there can be a variety of plastics, some of which are compatible for recycling, allowing them to be melt-mixed to create new materials with distinct properties. Common types of plastics found in waste streams include polypropylene (PP), polyethylene (PE), acrylonitrile butadiene styrene (ABS), polystyrene (PS), including high-impact polystyrene (HIPS), and polyvinyl chloride (PVC). The value of these plastics is enhanced when separated into “light” plastics (PP and PE) and “heavy” plastics (ABS and PS). However, certain plastics are considered undesirable, such as PVC and certain types of PP, including those filled with talc or glass fibers. To maximize the value of recycled plastics, it's critical to remove undesirable plastics from the mixture, resulting in a more uniform and higher-quality material.

Accordingly, there is always a need for improved method for improved methods and systems for separating materials. It is to this need among other that this application is directed.

### SUMMARY

One aspect of this application includes methods and systems for sorting plastics from waste material using a covered screen bed. Specific embodiments involve separating plastics through multiple processing steps, which include screening to create distinct streams of light, heavy, or sized plastics. These methods enable efficient removal of undesirable plastics and non-plastics, ultimately producing a stream of a single plastic type. The system is designed to process waste streams derived from recycling processes, including common plastics like polypropylene (PP), polyethylene (PE), acrylonitrile-butadiene-styrene (ABS), and polystyrene (PS).

Another aspect is a method for separating materials by feeding a waste stream into a screen of a specific size, allowing smaller materials to pass through while larger materials are collected for further processing. These larger materials can be directed to a first gravity separator with a specific gravity between 0.95 and 1.05, separating them into denser materials that sink and lighter materials that float. The lighter materials from this gravity separator are transferred to a second gravity separator with a specific gravity range of 1.05 to 1.25, further separating them into a second set of lighter materials and a second set of heavier materials. This method includes recovering the second set of heavier materials from the second gravity separator for subsequent processing or use. The first specific gravity can be set at 1.0, and the second specific gravity can be set at 1.2. The lighter plastics recovered from the second gravity separator can include polyethylene (PE) and polypropylene (PP), and the heavier plastics can include acrylonitrile-butadiene-styrene (ABS) and high-impact polystyrene (HIPS).

Another aspect involves a screen that is a covered screen bed with an agitator bed.

Another aspect concerns a screen with variable screening size. The screen can separate materials at 6 mm, with a screening capacity between 6 mm and 12 mm.

Another aspect involves a method where the first gravity separator is a sink-float gravity separator that separates materials based on specific gravity, with denser materials sinking and lighter materials floating.

Another aspect describes using a dewatering screen to remove excess moisture from separated materials.

Another aspect is a system for separating materials using a screen bed and gravity separators, with a covered screen bed designed to separate materials based on size; a first gravity separator set with a specific gravity between 0.95 and 1.05, which separates materials into denser materials that sink and lighter materials that float; and a second gravity separator set to a specific gravity between 1.05 and 1.25 to further separate the lighter and heavier materials. An extruder and pelletizer can process the concentrated plastic fraction and pelletize it for further use. The system is designed to process waste streams that include organics, textiles, foam, fuzz, and presorted metals.

Another aspect states that the first gravity separator or second gravity separator can comprise at least one of the following: liquid sink/float tank, sand flow separator, or hydrocyclone.

Another aspect is a method for separating materials using a screen bed and gravity separators, where a waste stream is fed into a screen bed with a specific mesh size to facilitate separation; larger materials are collected, while smaller materials pass through the screen; the larger materials are directed to a first gravity separator with a specific gravity between 0.95 and 1.05, where they are separated into denser materials that sink and lighter materials that float; then, the lighter materials are transferred to a second gravity separator, with a specific gravity between 1.05 and 1.25, to further separate the lighter and heavier materials. The recovered second set of heavier materials can then be processed for further use. The system can feature the first or second gravity separator comprising at least one of the following: liquid sink/float tank, sand flow separator, or hydrocyclone.

### BRIEF DESCRIPTION OF DRAWINGS

FIG. 1 illustrates an exemplary system that features a covered screen bed, which is operatively connected to a gravity separator;

FIG. 2 provides an exemplary cover that is part of the screen bed shown in FIG. 1;

FIG. 3 provides a sectional side view of the cover on the screen bed shown in FIG. 2;

FIG. 4 provides a top view of the agitator bed within the screen bed shown in FIG. 1;

FIG. 5 illustrates an exemplary agitator that can be used within the agitator bed shown in FIG. 4; and

FIG. 6 illustrates an exemplary method for screening materials.

### DETAILED DESCRIPTION

This application describes methods and systems for sorting plastics from waste material using a covered screen bed. Specific embodiments include separating plastics through multiple processing steps, which include a covered screen bed to create distinct streams of light and heavy plastics. These methods enable efficient removal of undesirable plastics and non-plastics, ultimately producing a stream of a single plastic type. The system is designed to process waste streams derived from recycling processes, including common plastics like polypropylene (PP), polyethylene (PE), acrylonitrile-butadiene-styrene (ABS), and polystyrene (PS). By efficiently sorting plastics, these methods aim to maximize revenue recovery while minimizing landfill waste.

Initial waste streams often contain various non-plastic materials such as rubber, wood, metal, wires, circuit boards, foam, and glass. The described methods use size reduction systems to sort these waste streams, resulting in multiple products and byproduct streams. These processes are applicable to various plastics-rich waste sources, including office automation equipment (printers, computers, copiers, etc.), white goods (refrigerators, washing machines, etc.), consumer electronics (televisions, stereos, etc.), automotive shredder residue, packaging waste, household waste, building waste, and industrial molding and extrusion scrap. In some embodiments, the initial waste stream or material has been treated with processes to recover the metals.

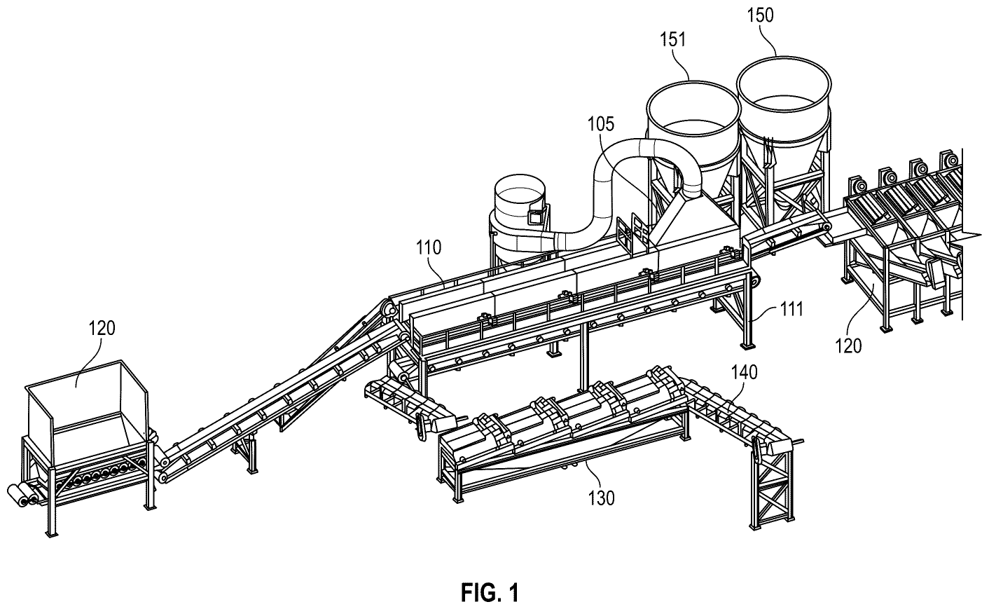

FIG. 1 shows an example of a system for separating material using a covered screen bed 110 having a cover 160 and a gravity separator 120. The screen bed or size separator 110 is a large, rectangular industrial structure with a sturdy frame, resembling a horizontal conveyor system with a slight upward incline leading to a screening area. As can be seen, material flows from the feeder 120 to the screen bed 110 using a conveyor 125. At the screen bed 110, the material is liberated and separated/screened without substantial dust and debris floating into the surrounding environment. As the material passes over the screen bed 110, the smaller material (e g., fuzz, textiles, foam, wood) can be further processed using, e.g., a high frequency screen 130. The larger material is then treated using one or more gravity separators 120. At this point, material such as wood or fuzz is removed and falls through the agitator bed. The bigger material or greater than, e.g., 6 mm, can move to a second screening bed with fluidization chamber, thereby causing lighter density material to be encapsulated within the air flow while heavier material (e.g., plastics) remains on the screening bed for further screening through the process or system. The lighter material (e.g., fuzz) can carried by the air flow into the fluidization chamber, and further into an expansion chamber or cyclone. The smaller material can be concentrated and discarded. There can also be a clarifier 150 and water supply 151.

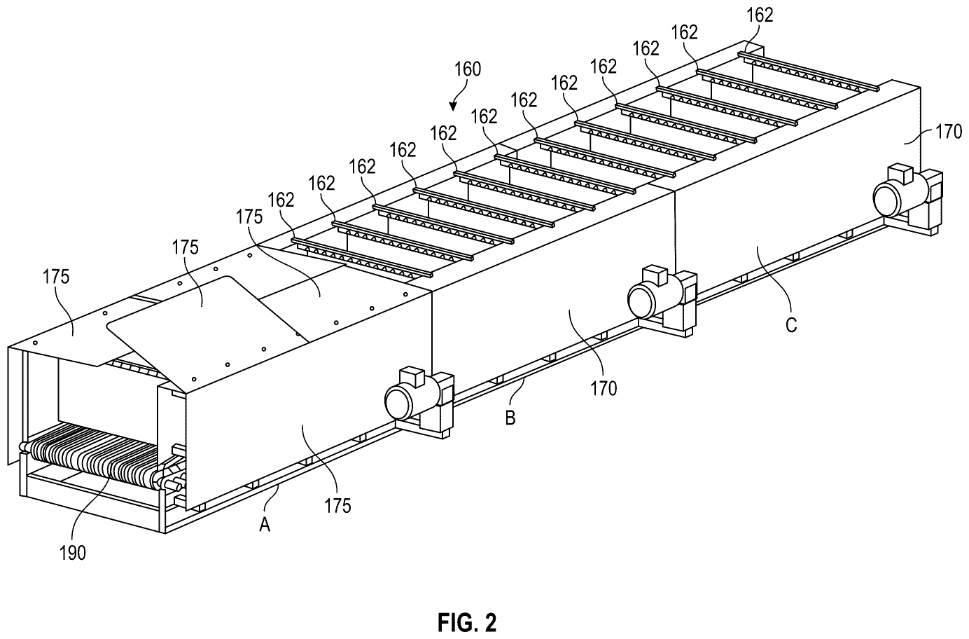

FIG. 2 shows an example of a cover 160 that is part of the screen bed 110. As can be seen, the cover 160 has side panels 170 to help prevent material from leaving the agitator bed 190. The cover can have top panels to prevent material, including dust, from entering the surrounding environment. The curtains or flaps 162 helps keep the material against the bed and help prevent material from becoming aerosolized or turning into particulate. The curtains 162 have provide an opening for the material to flow across the bed 110. The protective casing encloses the bed, covering between 80% and 99% of its surface or 85% and 95% of its surface, providing a barrier against dust and debris while shielding the system from external elements. The cover have varying zones (A, B, C).

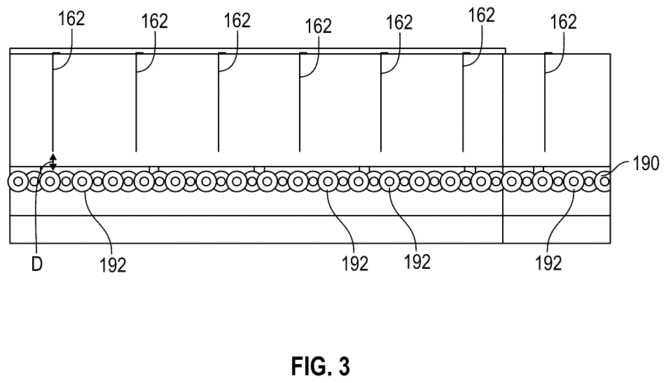

FIG. 3 shows a side sectional view of the cover 160. As can be seen the curtains 162 hang above the agitator bed 190 such that there is a distance between the curtain 162 and the agitator bed 190. This allows the material to flow across the agitator bed. In some examples, the cover height may be lower so to allow the material to bounce off the cover and improve separation.

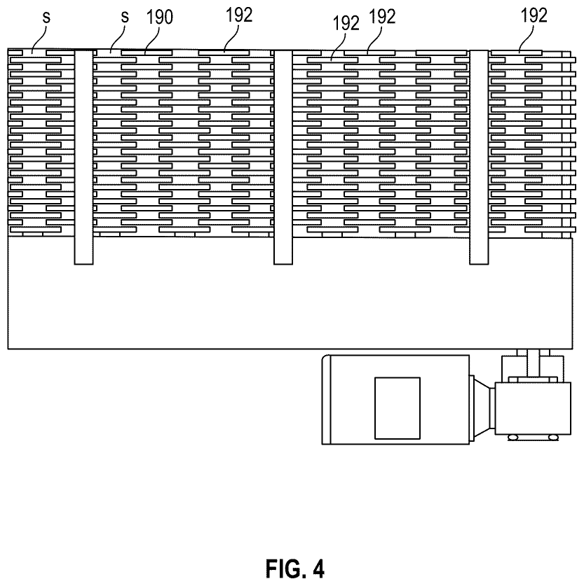

FIG. 4 shows a top view of the bed showing the agitator bed 190, which shows the star or agitators 192 interspersed. The platform contains a series of screening spaces with either predetermined or variable spacing. Material placed on the top side of the platform is agitated by the rotating shafts/stars 192 (shown in later figures), creating a dynamic screening process. As the shafts rotate, smaller material passes through the screening spaces, while larger material remains on the platform's surface. The constant agitation and rotation ensure effective sorting and prevent material build-up. The screen can a covered screen bed with an agitator bed with a screening capacity between 6 mm and 12 mm (e.g., 6 mm). A larger screen size can all more material to fall through, which can result in less final product. The material falls through space S having a screen size to the bottom may have been sorted for both size and weight or can be discarded.

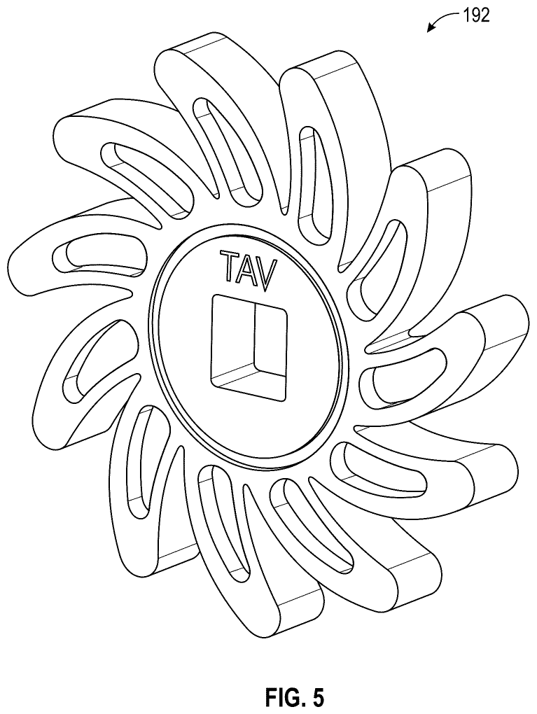

FIG. 5. shows an exemplary diagram of the material leaving the screen bed 120 that does not fall through the screen bed. In this embodiment, the system employs a covered screen bed for initial separation, followed by two gravity separators with specific gravity settings at 1.0 and 1.2, respectively. The method begins by feeding the waste stream into the covered screen bed, which sorts materials based on size and initial density. The larger and denser materials are retained on the screen bed, while smaller or lighter materials pass through the screen to a collection area.

The heavier materials from the screen bed can be directed to the first gravity separator, set at a specific gravity of 1.0. This sink-float device uses a liquid medium to separate materials based on density. In this step, denser materials, such as certain plastics and rubbers, sink to the bottom, while lighter materials float to the surface. The floating materials can be polyethylene (PE) and polypropylene (PP), which are collected, while the sinking materials are transferred to the second gravity separator or discarded.

The second gravity separator, set at a specific gravity of 1.2, further separates the materials. This stage is designed to recover plastics such acrylonitrile-butadiene-styrene (ABS) and high impact polystyrene (HIPS). The floating materials in the second separator are typically the lighter plastics (ABS and HIPS), while the sinking materials can be heavier plastics, residual metals, glass or other denser materials.

This two-step gravity separation method of this embodiment, in combination with the covered screen bed, allows for efficient and flexible sorting of materials. It can accommodate various waste streams and is suitable for recycling processes where different densities need to be separated, promoting a thorough and effective separation process.

Additional sorting processes can further purify the plastics by removing undesirable plastics and non-plastics. These methods can accommodate a mix of plastics from multiple sources, leading to a stream of purified plastics ready for extrusion and pelletization. This system can efficiently sort plastics like ABS, high impact polystyrene (HIPS), polystyrene (PS), polypropylene (PP), polyethylene (PE), polycarbonate (PC), polyamides (PA), polymethyl methacrylate (PMMA), polyvinyl chloride (PVC), and more.

In one embodiment, the heavier materials from the first screen bed undergo further separation using a sink-float process, which separates materials based on their specific gravity.

This process works by immersing materials in a fluid where denser materials sink, and less dense materials float. In plastics recycling, plastics with higher density will sink while those with lower density float. The first sink-float device contains multiple chambers with adjustable specific gravity, allowing for precise separation. The range for specific gravity (SG) is typically between 1.0 and 1.2, with varying sub-ranges depending on the target plastics.

Materials that sink in the first sink-float process typically consist of rubber or less desirable plastics. The floating materials are then transferred to a second sink-float device with similar separation principles but different specific gravity ranges. The second device's SG range typically lies between 0.95 and 1.05, allowing for efficient separation of lighter plastics like PP and PE from heavier materials like ABS and PS. The sorting process involves recovering lighter plastics like PP and PE from the heavier ones. By controlling the specific gravity of the liquid, these systems can effectively separate different plastics. Common specific gravities for plastics vary widely, providing flexibility in the sorting process.

As can be seen from FIG. 4, an exemplary embodiment of the system employs a screening bed with a cover, containing a series of shafts with adjustable agitators to facilitate material sorting as it moves through the screening device. The system uses a combination of air flow and screening beds to separate materials based on size and density. The lighter materials, like wood or fuzz, are removed through the air flow, while heavier materials remain on the screening bed for further processing.

A typical screen bed is a large industrial structure with multiple screens arranged at an angle, often enclosed to contain dust and debris. It is equipped with vibratory mechanisms to facilitate material movement and prevent clogging. These mechanisms, such as rotating shafts or vibrating motors, ensure efficient sorting. The bed includes discharge chutes directing separated materials to collection bins or conveyor belts. Access panels provide maintenance capabilities, and safety rails, industrial lighting, and control panels offer additional functionality.

In specific embodiments, star scalpers/agitators with flexible star fingers are used to separate materials. Some star fingers have scrapers to remove material from adjacent shafts. Dewatering screens can be used to further separate solids from liquids. This setup ensures effective and durable sorting while minimizing maintenance requirements. The star or agitators may vary in size. In specific embodiments, the star may range from 4 inches to 16 inches diameter. An exemplary star is shown in FIG. 5.

Specific embodiments of the system can handle waste streams containing a high concentration of plastics, typically 15% or more. The system is designed to handle materials from various sources, such as household waste, which have been pre-sorted into plastic and non-plastic streams. This flexibility allows the system to adapt to different waste sources and concentrations of plastics, ensuring effective and efficient sorting.

Exemplary embodiments of this invention provide methods and systems for sorting plastics from waste material using a covered screen bed. Such embodiments provide processes and systems for separating plastics with multiple processing steps, which using a covered screen bed and can result in streams of light plastics and heavy plastics. The methods include defining an arrangement to prepare a recycled plastic product. Further, specific methods and systems can allow for the removal of undesirable plastics and non-plastics from a stream so to produce product of a single plastic type. Specific embodiments provide cost-effective, efficient methods and systems for recovering plastics from a waste stream, such as materials seen in a recycling process, including polypropylene (PP), polyethylene (PE), acrylonitrile-butadiene-styrene (ABS) and polystyrene (PS), in a manner that facilitates revenue recovery while also reducing landfill requirements.

The initial waste streams contain amounts of rubber, wood, metal, wires, circuit boards, foam, glass and other non-plastics. Size reduction methods and systems configured to perform the processes have been developed such that feed streams rich in plastics can be separated into multiple products and byproduct streams. The methods and systems can be applied to a variety of plastics-rich streams derived from post-industrial and post-consumer sources. These streams can include plastics from office automation equipment (printers, computers, copiers, etc.), white goods (refrigerators, washing machines, etc.), consumer electronics (televisions, video cassette recorders, stereos, etc.), automotive shredder residue, packaging waste, household waste, building waste and industrial molding and extrusion scrap.

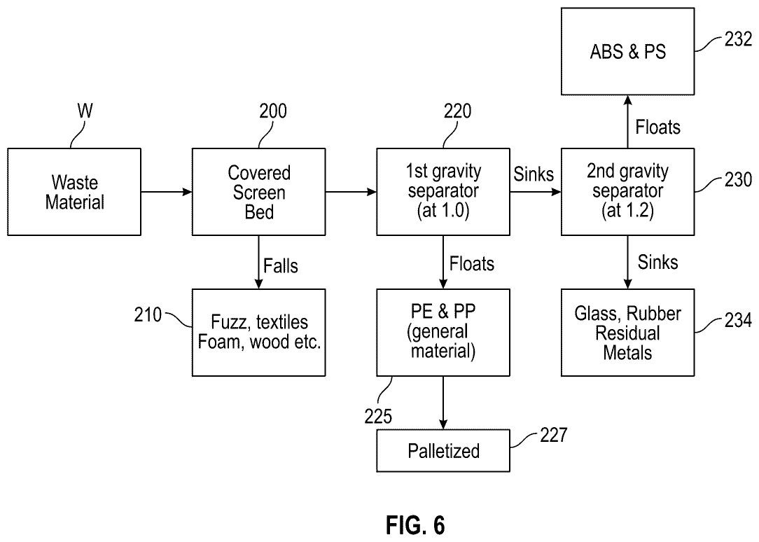

As shown in FIG. 6, specific embodiments include a method and system for treating the light fraction of metal separation processes. In metal separation processes, the light fraction refers to the portion of the input material that is less dense than the metal being recovered. This fraction typically consists of non-metallic materials such as plastics, rubber, glass, and other lightweight materials. The separation of the light fraction from the heavy fraction (the portion of the input material that contains the metal being recovered) is a step-in metal recovery processes or as in recycling. This separation is typically achieved using a combination of mechanical and/or pneumatic methods, such as air classifiers, vibrating screens, and cyclones.

FIG. 6 illustrates an exemplary method according to this application. The material, which may have been pre-processed to remove metals and other unwanted materials, is introduced into a covered screen bed or screen 200. The resulting unders, or smaller materials that pass through the screen, typically consist of fuzz, textiles, foam, wood, or other similar materials 210. The overs, or larger materials that do not pass through the screen, are directed to a first gravity separator set to a specific gravity 220 of approximately 1.0, separating the float materials, generally polyethylene (PE) and polypropylene (PP) 225, from the sink materials. These floating materials may be optionally pelletized 227. The sink materials from the first gravity separator are processed in a second gravity separator 230, set to a specific gravity of approximately 1.2, which separates the float materials 232, such as acrylonitrile-butadiene-styrene (ABS) and polystyrene (PS), from the sink materials. The sink materials 234 at this stage can include glass, rubber, talc-filled plastics, and other residual metals.

Once the light fraction has been separated, the light fraction may be further sorted and processed to recover any recyclable materials and to recover plastics for recycling and retail. Specific embodiments allow the material from the waste stream to be purified or separated to remove undesirable plastics and non-plastics from a stream of a family of multiple plastic types. Plastics from more than one source of durable goods may be included in the mix of materials fed to a plastics recycling plant. Exemplary plastics include acrylonitrile-butadiene-styrene (ABS), high impact polystyrene (HIPS), polystyrene (PS), polypropylene (PP), polyethylene (PE), polycarbonate (PC), polyamides (PA), polymethyl methacrylate (PMMA), polyvinyl chloride (PCV), polyether ether ketone (PEEK), polysulfone (PSU), polyoxymethylene (POM) and others. Plastic-bearing materials can be separated into light plastics from heavy plastics. After the materials are separated, the purified plastics can be concentrated, extruded, and pelletized.

The heavier material from the second screen bed can be further separated using a first sinkfloat device or first gravity separator. A sink-float device can separate materials with different densities, such as plastics. The process works by taking advantage of the fact that materials with a higher density than the liquid will sink, while materials with a lower density than the liquid will float. For example, in a sink-float system for plastics recycling, the plastic pieces are placed into a tank of water. Because some plastics have a higher density than water, they will sink to the bottom, while others with a lower density will float on top. In this device, the materials are placed into a liquid, typically water or media, and allowed to sink or float based on their density. This first sinkfloat device can include various units with tanks that allows the fluid move slowly. The first sinkfloat device can have multiple chambers with augers to help separate the materials. In one example, the SG is between 1 and 1.2. In another example, the SG is between 1.05 and 1.15. In another example, the SG is at 1.15 or about 1.15.

The material that sink from the first sink-float devices can be rubbers or less desirable plastics. The floating materials are then transferred to a second sink-float device. This device can have multiple zones and units. In one example, the SG is between 0.95 and 1.05. In another example, the SG is between 0.98 and 1.03. In another example, the SG is at 1.0 or about 1.0.

The lighter material or material that float can generally PP/PE and the heavier material can be materials such as ABS and PS. By controlling the density of the liquid, it's possible to separate materials with different densities effectively.

The specific gravity of a material is a measure of its density relative to water. Since different plastics have different densities, specific gravity can be used as a method for separating them. Here are some common specific gravities for various types of plastics:
Polyethylene (PE): Specific gravity ranges from 0.92 to 0.96.
Polypropylene (PP): Specific gravity ranges from 0.89 to 0.91.
Polyvinyl chloride (PVC): Specific gravity ranges from 1.38 to 1.59.
Polystyrene (PS): Specific gravity ranges from 1.04 to 1.10.
Polyethylene terephthalate (PET): Specific gravity ranges from 1.38 to 1.40.
Acrylonitrile butadiene styrene (ABS): Specific gravity ranges from 1.03 to 1.06.

To separate plastics based on their specific gravity, a technique called sink-float separation is commonly used. This involves placing the plastic particles in a liquid medium with a specific gravity between those of the different plastic types. The plastics that have a higher specific gravity will sink, while those with a lower specific gravity will float. By adjusting the specific gravity of the liquid medium, it is possible to separate different types of plastics from each other.

In exemplary embodiment, the method or system employs a screening bed, with a cover, having a series of shafts having agitators adjustably and/or non-adjustably connected to rails. In this embodiment, the shafts are positioned along the rails to help sort the materials as they pass through the screening device or bed. As the materials pass along the screening bed, materials may be sorted based on size by the agitators. The small elements (e.g., less than 6 mm) that dropped through the star openings may be conveyed via a conveyor belt or may fall to a bin located proximate or underneath the screening bed.

The screen bed incorporates visible vibratory mechanisms, such as rotating shafts or vibrating motors attached to the frame, designed to facilitate material movement and prevent clogging. These vibratory components ensure a smooth flow of materials through the system. The protective casing has curtains or flaps attached along its length to further contain dust and debris during operation, enhancing both dust control and protection from the elements. A screen bed is disclosed in U.S. Pat. No. 10,363,578 to Thomas A. Valerio, which is incorporated by reference.

At the bottom or sides of the structure, discharge chutes guide separated materials into designated collection bins or onto conveyor belts for further processing or disposal. The screen bed is designed with maintenance in mind, featuring easily accessible panels along the sides of the frame. These panels allow operators to inspect or replace components without dismantling the entire structure. Additional safety features may include safety rails, industrial lighting for visibility, and control panels for operating the vibratory mechanisms and other mechanical components.

In one embodiment, the screen bed incorporates star scalpers or agitators with adjacent shafts. The star body has a hub with radially protruding star fingers and an aperture for securing it to a shaft of the star scalper. Some star fingers may include scrapers at their extremities, designed to scrape along the hub on an adjacent shaft to prevent material build-up. The star fingers might be flexible in the axial direction to aid in this process, ensuring robust and low-maintenance separation.

Specific embodiments, with a protective cover that encloses 80% to 95% of the screen bed, along with curtains or flaps, vibratory mechanisms, and robust safety features, provides an effective solution for material separation. Other embodiments may include a cover on more than 15% of the bed, or 25% of the bed, or 45% of the bed, or 55% of the bed or 65% of the bed or 75 or 85% of the bed. It minimizes dust and debris escape while facilitating a clean and safe working environment.

In one embodiment, multiple screens or screen beds can be used in tandem, with variations in size and rotational speed. For example, one screen bed may have an agitator rotating at 300 RPM, while another may rotate at 350 RPM or 450 RPM, allowing for customized separation based on different material characteristics and processing needs.

FIGS. 1-3 depict an exemplary screening bed 110, a motor-driven platform with a frame 111 and a series of rotatable shafts 192 mounted within the frame 111 using bearings. The frame 111 is designed with rails to support the shafts, allowing them to rotate freely while providing stability. The motor (not shown) powers the rotatable shafts, typically through a belt or chain drive system, ensuring smooth and reliable operation. The axes of the rotatable shafts are aligned substantially parallel when fitted into the frame 111. The frame 111 can have grooves along the rails, providing space to adjust the positioning of the bearings and allowing for variable spacing between the shafts. This flexibility lets operators modify the distance between the shafts by adjusting the bearings, which in turn determines the size of the screening spaces. This ability to vary the spacing offers versatility in screening different types of materials. The screen may be 8 inches, 16 inches, 24 inches or 30 inches from the agitating bed.

One embodiment can include a dewatering screen. A dewatering screen is a mechanical device used to separate solids from liquids, typically in the context of industrial or mining applications. The screen works by applying a force to the mixture of solids and liquids, which causes the liquid to pass through the screen while the solid material is retained. The process of dewatering involves removing excess water from the mixture of solids and liquids, which can be accomplished by using a dewatering screen. These screens typically have a high frequency linear vibration that causes the solid material to move across the screen while the liquid is separated and collected below.

Specific embodiments can separate the light fraction from metal recovery processes. The light fraction generally consists of non-metallic materials like plastics, rubber, and glass. This separation is typically accomplished using mechanical or pneumatic methods such as air classifiers, vibrating screens, and cyclones. These methods allow for further processing to recover recyclable materials, including plastics, for recycling and retail purposes.

With regards to the waste stream, specific embodiments can be used to process waste materials or recyclable material that contains a concentration of plastics larger than 15%, or 25%, 35%, 45%, and/or 50%. This means that as long as there is a good concentration of plastics (as low as 20% or larger) the system can properly sort the materials. Household waste that has been presorted into “plastic and non-plastic”streams will be a good example.

Typically household waste that is not landfilled can be presorted at a recycling facility where plastics separation will be generated. This plastics concentrate is one example of a “good feed material.” Municipal waste containing plastics is an exemplary waste stream material.

The terms “heavier” and “lighter” used in this context indicate relative specific gravity, with “heavier” referring to materials with greater specific gravity and “lighter” to those with lesser specific gravity. Within a fluid-based separator, buoyancy is more significant than absolute weight. For example, a one-pound object can be lighter than a six-ounce object if the specific gravity of the one-pound object is lower than that of the six-ounce object.

Gravity separators are devices or systems that use gravity-based principles to separate materials based on their relative densities. These separators work by taking advantage of the natural tendency of denser materials to sink while less dense materials float when immersed in a liquid or gas medium. Commonly used in various industries, gravity separators are effective for sorting and purifying materials, especially when size or magnetic properties cannot be relied upon. One of the most popular types of gravity separators is the sink-float separator. Denser materials will sink to the bottom, while lighter materials float on the surface, allowing for effective separation. This technique is particularly useful in recycling to separate plastics, where different types of plastics have varying specific gravities. For example, polyvinyl chloride (PVC) has a higher specific gravity than polyethylene (PE), allowing them to be separated using a sink-float system.

Another example is the air classifier, which uses air flow to separate materials based on density and shape. Materials are introduced into a chamber with controlled air flow; heavier or denser particles fall to the bottom, while lighter ones are carried upwards or to the side by the air current. This method is commonly used to separate fines from larger particles or to remove lightweight contaminants from a product stream.

The plastics recycling processes can utilize a number of separation processes that are ordered to optimize efficiency and to create a valuable combination of products. The ordering can depend on the source, the particle size, and properties of the waste plastic material. In particular implementations, some operations can be repeated if required to achieve a desired purity or if the operations are required for different reasons at different stages in the process.

Although specific embodiments of the disclosure have been described above in detail, the description is merely for purposes of illustration. It should be appreciated, therefore, that many aspects of the disclosure were described above by way of example only and are not intended as required or essential elements of the disclosure unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed:

1. A method for separating materials using a screen and gravity separators, comprising:
feeding a waste stream comprising plastics and non-plastics into a screen to facilitate separation;
collecting larger materials from the waste stream, allowing smaller materials to pass through the screen;
directing the larger retained materials to a first gravity separator containing a fluid medium with a specific gravity between 0.95 and 1.05, which separates them into first denser materials that sink and first lighter materials that float;
transferring the first denser materials from the first gravity separator to a second gravity separator, set to a specific gravity between 1.05 and 1.25, which separates the transferred first denser materials into second lighter materials that float and second heavier materials that sink; and
recovering at least one of the second lighter material and the second heavier material from the second gravity separator to produce at least one purified plastic stream.

2. The method of claim 1, wherein the screen is a covered screen bed with an agitator bed, the cover enclosing between 80% and 95% of a surface of the bed and including curtains or flaps along its length.

3. The method of claim 1, wherein the screen separates at 6 mm.

4. The method of claim 1, wherein the screen bed has a screening opening size between 6 mm and 12 mm.

5. The method of claim 1, wherein the first gravity separator is a sink-float device containing a liquid medium to separate materials based on specific gravity, with denser materials sinking and lighter materials floating.

6. The method of claim 1, further comprising using a dewatering screen to remove excess moisture from the separated materials.

7. The method of claim 1, wherein the specific gravity of the first gravity separator is set at 1.0.

8. The method of claim 1, wherein the specific gravity of the second gravity separator is set at 1.2.

9. The method of claim 1, wherein the waste stream contains various non-plastic materials such as rubber, wood, metal, wires, circuit boards, foam, and glass, optionally after prior metal recovery.

10. The method of claim 1, wherein the first gravity separator precedes the second gravity separator.

11. The method of claim 1, wherein floating plastics recovered from the first gravity separator include polyethylene (PE) and polypropylene (PP) while the heavier plastics include acrylonitrile-butadiene-styrene (ABS) and high-impact polystyrene (HIPS) and floating plastics recovered from the second gravity separator include acrylonitrile-butadiene-styrene (ABS) and high-impact polystyrene (HIPS).

12. The method of claim 1, further comprising extruding and pelletizing the recovered plastics.

13. The method of claim 1, wherein the waste material comprises automobile shredder residue or whitegoods shredder residue.

14. The method of claim 1, wherein the first lighter materials include polypropylene (PP) and polyethylene (PE).

15. The method of claim 1, wherein the second lighter materials include acrylonitrile-butadiene-styrene (ABS) and high-impact polystyrene (HIPS).

16. A system for separating materials using a covered screen bed and gravity separators, comprising:
a. a covered screen bed designed to separate materials based on size, the screen bed comprising an agitator bed and a protective cover enclosing between 80% and 95% of a surface of the bed and including curtains or flaps;
b. a first gravity separator set with a first specific gravity between 0.95 and 1.05, which separates materials into first denser materials that sink and first lighter materials that float, the first gravity separator containing a fluid medium; and
c. a second gravity separator set to a specific gravity between 1.05 and 1.25 to separate the transferred first denser materials into second lighter materials that float and second heavier materials that sink.

17. The system of claim 16, wherein the first specific gravity of the first gravity separator is set at 1.0.

18. The system of claim 16, wherein the specific gravity of the second gravity separator is set at 1.2.

19. The system of claim 16, wherein the covered screen bed has rotatable, adjustable agitators comprising star scalpers with flexible star fingers optionally including scrapers to facilitate material movement and prevent clogging.

20. The system of claim 16, wherein the covered screen bed is equipped with vibratory mechanisms to ensure efficient sorting of materials.

21. The system of claim 16, further comprising a dewatering screen to remove excess moisture from the separated materials.

22. The system of claim 16, wherein the cover contains dust and debris during the sorting process by enclosing between 80% and 95% of the screen bed surface.

23. The system of claim 16, wherein the first gravity separator uses a sink-float process to separate materials based on specific gravity, with denser materials sinking and lighter materials floating.

24. The system of claim 16, further comprising an extruder and a pelletizer to process recovered plastic fraction and pelletize it for further use.

25. The system of claim 16, configured to handle waste streams comprising organics, textiles, foam, and fuzz, optionally with metals pre-removed.

26. The system of claim 16, wherein agitators have diameters between 4 inches and 16 inches.

27. The system of claim 16, configured to recover plastics including acrylonitrile-butadiene-styrene (ABS), high-impact polystyrene (HIPS), polystyrene (PS), polypropylene (PP), and polyethylene (PE).

28. The system of claim 16, wherein the first gravity separator or second gravity separator comprises at least one of: liquid sink/float tank, air classifier, and hydrocyclone.

29. A method for separating materials using a screen and gravity separators, comprising:
feeding a waste stream into a screen to facilitate separation; collecting the larger materials from the waste stream, while allowing smaller materials to pass through the screen;
directing the larger materials to a first gravity separator set at a specific gravity between 0.95 and 1.05, where the materials are separated into first denser materials that sink and first lighter materials that float;
transferring the first denser materials from the first gravity separator to a second gravity separator, set to a specific gravity between 1.05 and 1.25, to further separate the transferred first denser materials into a second set of lighter materials and a second set of heavier materials; and recovering at least one of the second set of lighter materials and the second set of heavier materials from the second gravity separator.

30. The method of claim 29, wherein the first gravity separator or second gravity separator comprises at least one of: liquid sink/float tank, air classifier, and cyclone or hydrocyclone.
